(19) United States
(12) Patent Application Publication
(10) Pub. No.: US 2024/0100538 A1
(43) Pub. Date: Mar. 28, 2024

(54) RECYCLING SYSTEM

(71) Applicant: Pocket Coil Recycling, LLC, Florence, KY (US)

(72) Inventors: Craig Conrad, Ft. Mitchell, KY (US); Eric Buck, Elsmere, KY (US); Nick Ruehlman, Lawrenceburg, IN (US)

(21) Appl. No.: 18/469,091

(22) Filed: Sep. 18, 2023

Related U.S. Application Data
(60) Provisional application No. 63/578,757, filed on Aug. 25, 2023.
(60) Provisional application No. 63/375,931, filed on Sep. 16, 2022.

(51) Int. Cl. B02C 23/10; B02C 4/08

(52) U.S. Cl. CPC B02C 23/10; B02C 4/08

(57) ABSTRACT

A system for recycling pocketed metal coil mattresses includes a primary shredding station that implements a primary shredder element having a housing with opposing shafts mounted to extend along sidewalls of the housing. Each shaft includes a plurality of opposing shredding knives configured to bypass each other for shredding materials in the housing into metal and fabric pieces. The knives each have a thickness in the range of 17-50 mm with the knives of each respective opposing shaft being spaced apart from each other along the respective shaft in the range of 17-50 mm. The primary shredder element is free of stationary elements in the spaces between the shredding knives at the sidewalls. A motion separation station utilizing motion of the fabric pieces and the metal pieces for separating the pieces follows the primary shredder station. An air separation station provides an airflow to separate fabric pieces from the metal pieces. A secondary shredding station for further shredding the material is used to further shred and separate materials. A magnetic separation station further separates the metal and fabric pieces.

### CROSS-REFERENCE TO RELATED APPLICATIONS

This application claims the benefit of priority to U.S. Provisional Patent Application Ser. No. 63/578,757 filed Aug. 25, 2023 (pending) and U.S. Provisional Patent Application Ser. No. 63/375,931 filed Sep. 16, 2022 (pending), the disclosures of which are incorporated by reference herein.

### TECHNICAL FIELD

This application is directed to recycling systems, and particularly to the recycling of items that incorporate metal and fabric together in a structure.

### BACKGROUND OF THE INVENTION

Various items used in daily life are made of materials that may be recycled for re-use in other manners. Materials like metal, plastics, glass and paper that are used to make various items are often recycled and re-tasked in making other similar or different items. Recycling provides reusable raw materials for manufacturing and also reduces the amount of materials that have to be handled in landfills.

Various items that use multiple recyclable materials often have to be processed to separate the materials so that they can be repurposed for different uses. For example, chemicals such as plastics are separated from and recycled differently than paper or metals. Oftentimes various materials are shredded or crushed into more uniform and smaller pieces from the original items in which they were used. In such a process, certain items, because of their shape and physical makeup are more difficult to recycle. One particular such item is bed mattresses.

Bed mattresses, for example, often are in the form of a plurality of metal coils that are arranged side-by-side to form the sleeping surface and shape of the mattress. Such coils, for noise reduction and manufacturing purposes, are often inserted into fabric pockets that are then secured together into the finished mattress. The fabric pockets are often constructed from a fabric made using synthetic or plastic materials. Therefore, when a mattress is recycled, the metal and fabric will be processed differently and must be broken down and separate in the recycling process.

Such recycling of pocketed metal coil mattresses has proven to be very difficult both from the standpoint of the shape of the mattresses and based on their construction. Therefore a solution improving the recycling process and outcome is needed in the industry.

### SUMMARY OF THE INVENTION

A system for recycling pocketed metal coil mattresses includes a primary shredding station that implements a primary shredder element having a housing with opposing shafts mounted to extend along sidewalls of the housing. Each shaft includes a plurality of opposing shredding knives configured to bypass each other for shredding materials in the housing into metal and fabric pieces. The knives each have a thickness in the range of 17-50 mm with the knives of each respective opposing shaft being spaced apart from each other along the respective shaft in the range of 17-50 mm. The primary shredder element is free of stationary elements in the spaces between the shredding knives at the sidewalls.

A motion separation station utilizing motion of the fabric pieces and the metal pieces for separating the pieces follows the primary shredder station. An air separation station provides an airflow to separate fabric pieces from the metal pieces. A secondary shredding station for further shredding the material is used to further shred and separate materials. The output of the secondary shredding station is then directed through another separation station including a magnetic separation station wherein remaining shredded metal pieces are captured while any remaining fabric pieces are collected and baled.

### BRIEF DESCRIPTION OF THE DRAWINGS

FIG. 1 is a plan view of a recycling system in accordance with an embodiment of the invention.

FIG. 2 is a side view of a portion of the recycling system of FIG. 1 in accordance with an embodiment of the invention.

FIG. 3 is a top view of another portion of the recycling system of FIG. 1 in accordance with an embodiment of the invention.

FIG. 3A is a top view of an alternative portion of the recycling system of FIG. 1 in accordance with an embodiment of the invention.

FIG. 4 is a side view of another portion of the recycling system of FIG. 1 in accordance with an embodiment of the invention.

FIG. 4A is a cross-sectional side view of a secondary shredder element in accordance with an embodiment of the invention.

FIG. 5 is a side view of another portion of the recycling system of FIG. 1 in accordance with an embodiment of the invention.

FIG. 6 is a top view of a shredder mechanism used in the recycling system of FIG. 1 in accordance with an embodiment of the invention.

FIG. 6A is a top view of a shredder mechanism used in the recycling system of FIG. 1 in accordance with another embodiment of the invention.

FIG. 7 is a side view a shredder mechanism used in the recycling system of FIG. 1 in accordance with an embodiment of the invention

FIGS. 8-11 are exemplary knife elements for use in the shredder mechanism of FIG. 6 in accordance with an embodiment of the invention.

FIG. 12 are graph illustrating placement of knife elements for use in the shredder mechanisms of FIGS. 6, 6A in accordance with an embodiment of the invention.

FIG. 13 is a plan view of a recycling system in accordance with another embodiment of the invention.

FIG. 14 is a side view of another portion of the recycling system of FIG. 13 in accordance with an embodiment of the invention.

FIG. 15 is a side view of another portion of the recycling system of FIG. 13 in accordance with an embodiment of the invention.

FIG. 16 is a plan view of a recycling system in accordance with another embodiment of the invention.

FIG. 17 is a side view of another portion of the recycling system of FIG. 16 in accordance with an embodiment of the invention.

FIG. 18 is a side view of another portion of the recycling system of FIG. 16 in accordance with an embodiment of the invention.

FIG. 19 is a plan view of a recycling system in accordance with another embodiment of the invention.

FIG. 20 is a side view of another portion of the recycling system of FIG. 19 in accordance with an embodiment of the invention.

FIG. 21 is a plan view of a recycling system in accordance with another embodiment of the invention.

FIG. 22 is a side view of another portion of the recycling system of FIG. 21 in accordance with an embodiment of the invention.

FIG. 23 is a plan view of a recycling system in accordance with another embodiment of the invention.

FIG. 24 is a side view of another portion of the recycling system of FIG. 23 in accordance with an embodiment of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF EMBODIMENTS OF THE INVENTION

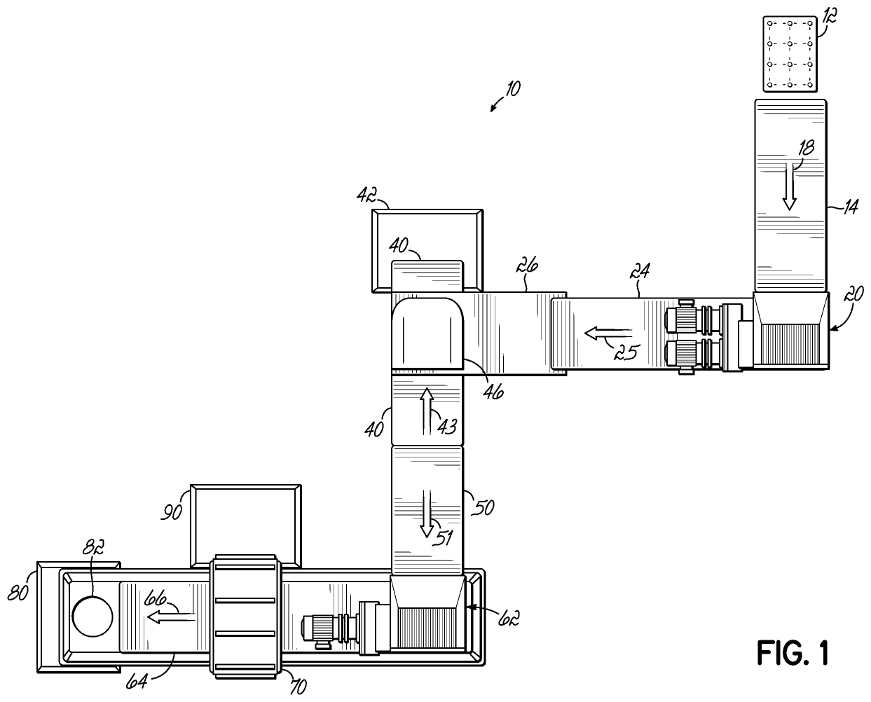

FIG. 1 illustrates a top plan view of a recycling system 10 in accordance with the invention. In one particular embodiment of the system 10, the system is utilized to recycle mattress components, including mattresses made with coil springs contained in fabric pockets. The coil springs might also be surrounded and enclosed by one or more outer layers of fabric material that contain the coils together to form the mattress unit. Accordingly, the system 10 is utilized to recycle both the metal of the coil springs as well as the fabric components, with the fabric made of a synthetic material, such as non-woven and needle punch polypropylene fabric.

The system 10 incorporates a primary shredding process and station, followed by a separation station/process utilizing both air and motion separation to separate fabric and metal. Next, a secondary shredding station/process is used to further separate materials. The output is then directed through another separation station/process utilizing motion separation and then to a magnetic separation station/process wherein remaining shredded metal pieces are captured while any remaining fabric pieces are collected and baled. The metal and shredded fabric may then be further recycled and processed as appropriate.

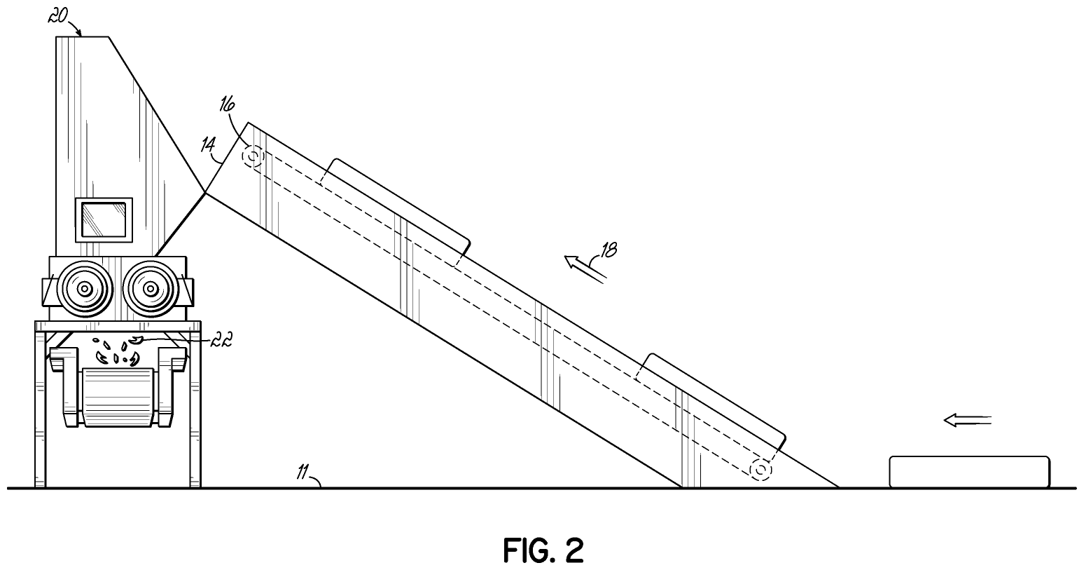

Specifically, referring to FIG. 1, a mattress structure or other recyclable unit 12 is initially presented to a conveyor element or conveyor 14. The conveyor 14 may be a belt conveyor incorporating a looping belt 16 as illustrated in FIG. 2 or may be another suitable conveyor for moving the unit(s) 12 in the direction of arrow 18 toward a primary shredding station with a primary shredder element 20. Herein, many of the conveyor elements are illustrated as belt-type conveyors, but other appropriate conveyor elements might be used as long as they keep the shredded or ground elements from falling through the conveyor. In one embodiment, the conveyor 14 is a concave shaped slider belt conveyor having a 30 inch belt 16 that may use chevron cleats (not shown) or other structures for conveyance. In one embodiment, the conveyor 14 operates at 260 feet per minute (fpm) but other suitable conveyors might move at a speed of 100 to 400 feet per minute (fpm). In one embodiment of the invention as illustrated in FIG. 2, the conveyor 14 is inclined at an angle to the floor to move unit 12 to a shredder element raised above a floor surface 11, (e.g. 11 ft., 6 in. discharge height). In that way, the material output 22 from the shredder element 20, which includes both metal pieces and non-metallic or fabric material pieces, may drop vertically down from the shredder onto another conveyor 24 where the various pieces are carried for further sorting and processing in the direction of arrow 25.

The shredder element or device 20 as discussed further below is a single dual-shaft shredder that is uniquely and specifically configured for handling fabric covered metal coils. The shredder provides desirable shredding without clogging and is capable of a throughput of around 5000 lbs/hour. Often, the material that covers coils is a plastic material. Using commercially available shredders has resulted, after a certain throughput, in melting and subsequent hardening of such plastic material in the shredder, thus requiring many hours to disassemble the shredder, clean the knives and other surfaces and get the shredder operating again.

The shredded pieces drop to conveyor 24 which may be a belt conveyor or other appropriate conveyor that is 20 feet long in one embodiment, but the length of such conveying elements may vary as necessary. The conveyor 24 might also be a concave shape slider belt conveyor having a 30 inch wide belt 27 that may use chevron cleats (not shown) or other structures for conveyance. In one embodiment, the conveyor 14 operates at 260 feet per minute (fpm) but other suitable conveyors might move at a speed of 100 to 400 feet per minute (fpm).

The pieces are conveyed to a separation station/process that uniquely utilizes a combination a motion separation station and an air separation station to separate the fabric material and metal pieces. That is, the process provides both mechanical or motion separation and also air separation. The conveyed non-metallic and metal parts 22 from the shredding station move to a motion separation station and specifically drop from conveyor 24 onto a vibratory conveyor 26 that provides motion through shaking or vibration and conveyance of the shredded pieces 22 to provide physical mechanical separation of the shredded metal and the shredded fabric pieces. One suitable vibratory conveyor or table 26 has a length of around 10 feet and a width of around 30 inches. The vibratory conveyor provides a flow rate of around 85 feet per minute. One suitable vibratory conveyor 26 is an IMLS 1880520 vibratory conveyor available from Carrier Vibrating Equipment of Louisville Ky.

The inventors have discovered that a unique vibratory scheme improves the separation process. In one embodiment of the invention, the vibratory frequency of a vibratory conveyor 26 the present invention is in a frequency range of 100-1000 strokes per minute. One specific vibratory conveyor frequency is 520 strokes per minute. The vibratory stroke length may be in the range or ¼ inches-2 inches. One specific vibratory stroke length is around ⅞ inches.

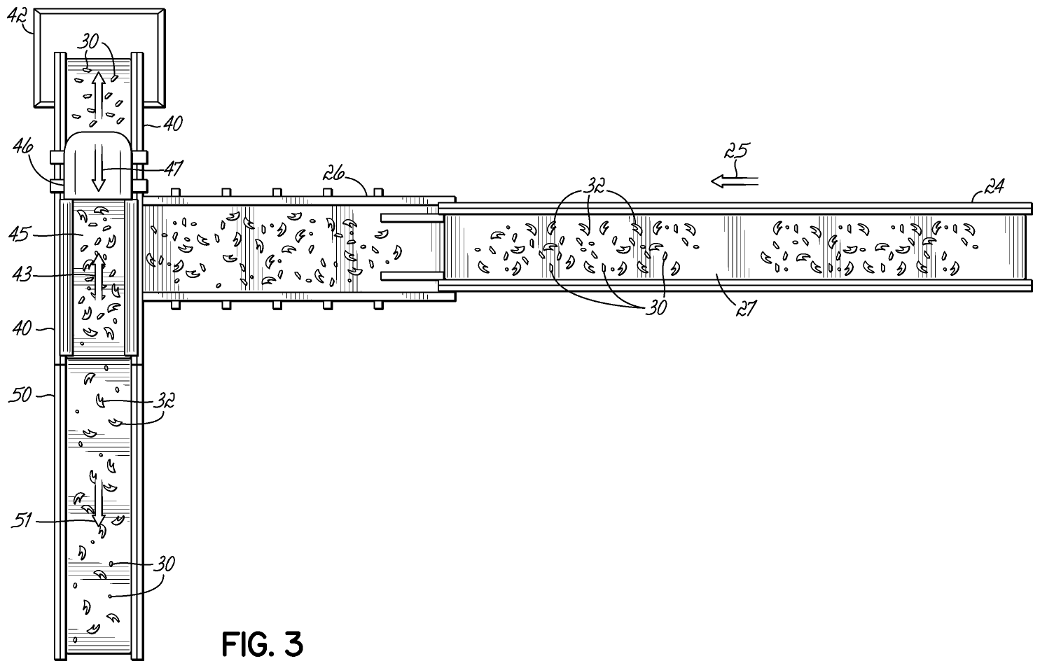

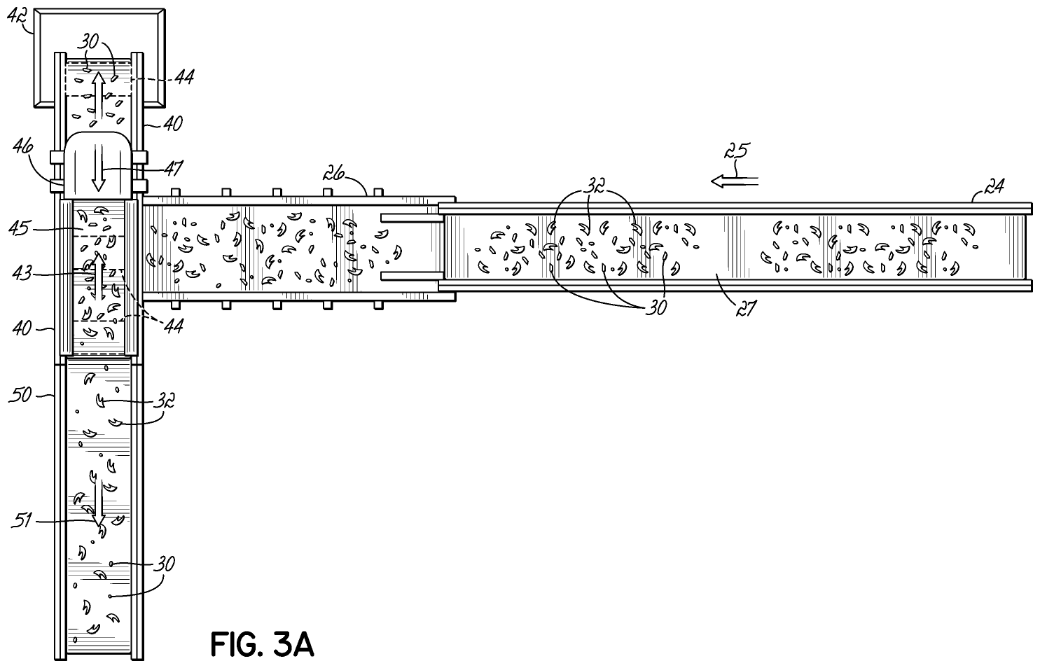

FIG. 3 illustrates a closer top plan view of the conveyor 24 and vibratory conveyor 26 illustrating the combination of metal pieces 30 and non-metallic, fabric or material pieces 32 mixed together on both the conveyor 24 and vibratory conveyor 26. The contents of the vibratory conveyor 26 are dropped onto another separation conveyor 40 that is configured for moving the metal pieces 30 in the direction of arrow 43 into a collection bin 42 and simultaneously exposing the material flow to an air separation station simultaneously with the mechanical separation. Specifically, the vibratory conveyor 26 vibrates and deposits the physically separated and intermixed pieces onto separation conveyor 40 that is arranged to provide travel in a direction 43, that is generally perpendicular to the direction of travel for the conveyor 24 and the vibratory conveyor 26. The separation conveyor 40 may be a typical conveyor, such as a belt conveyor having an endless belt 45, or another suitable conveyor. The separation conveyor 40 might be around 12 feet long with a 26 inch wide belt 45 that may use cleats (not shown) or other structures for conveyance. In one embodiment, the conveyor 14 operates at 240 feet per minute (fpm) but other suitable conveyors might move at a speed of 100 to 400 feet per minute (fpm). The cleats may have heights between ⅛ inch up to 1 inch for aiding in metal and fabric separation in the air separation stage.

At the same time that separation conveyor 40 is moving the pieces in the direction of arrow 43, an air separation station that incorporates a blower system/element 46 is positioned to intercept the flow of material pieces 30, 32 as they move from the vibratory conveyor 26 onto the conveyor 40. The air separation station separates the heavier and lighter elements. In the example of shredding fabric pocketed coil springs of a mattress, the air separation station separates the lighter fabric from the heavier metal pieces. The blower element of the air separation station might be a 10-20 HP blower and provides air separation of the material. The blower system 46 introduces a directed airflow stream over the material 30, 32 on the separation conveyor 40 generally in the direction of arrow 47 that is opposite to the movement of conveyor 40 in the direction of arrow 43. The airflow stream from the blower system 46 may provide an airflow volume of around 5000 CFM and the blower system includes a variable frequency drive to adjust the airflow volume as needed using a 10-20 horsepower blower element. The airflow is configured to intercept the flow of pieces 30, 32 that vibrate off of the vibratory conveyor 26 and onto the moving conveyor 40. The airflow will have a greater affect on the lighter weight fabric material 32 than on the heavier metal pieces 30. That airflow stream force provided by the blower system 46 is sufficient to lift the fabric pieces 32 from conveyor 40 and into the air while generally leaving the metal pieces 30 sitting on the conveyor 40 to be conveyed into a collection bin 42 as illustrated in FIG. 3.

In that way, a large amount of the fabric pieces will float or be blown off of conveyor 40 and onto another conveyor 50, as they come from the vibratory conveyor 26. That provides the completion of a primary shredding and sorting portion of the system 10. A byproduct of that primary shredding and sorting process is the collection of the mostly metal pieces 30 in the collection bin 42 from conveyor 40. The airflow of fabric pieces 32, with some metal pieces 30, is delivered to the conveyor 50, such as a belt conveyor or other conveyor. Conveyor 50 acts as an infeed conveyor for a secondary shredding process and conveys the material pieces and any remaining metal pieces in the direction of arrow 51 as shown in FIG. 3. The belt of conveyor 50 may use cleats (not shown) or other structures for conveyance and the cleats may have heights of around 3 inches for aiding in fabric capture and conveyance following separation in the air separation stage. Conveyor 50 may be 28 feet in length in one embodiment with a belt width of around 48 inches. The conveyor operates at 115 feet per minute (fpm) but other suitable conveyors might move at a speed of 25 to 300 feet per minute (fpm). The conveyor 50 collects and conveys what is delivered to that conveyor by the current of air from the blowing station 46. The material pieces 30, 32 are then carried to a secondary shredding station and process.

FIG. 3A illustrates an alternative embodiment of the invention and a top plan view of the conveyor 24 and vibratory conveyor 26 illustrating the combination of metal pieces 30 and fabric pieces 32 and their separation. Common elements with the portion shown in FIG. 3 share similar reference numerals. In the embodiment illustrated in FIG. 3A, the separation conveyor 40 incorporates magnetic sections 44 along the length of the conveyor. The magnetic sections 44 might be around 2 feet in length and positioned at intervals along the length of the conveyor 40. As noted, the airflow is configured to intercept the flow of pieces 30, 32 that vibrate off of the vibratory conveyor 26 and onto the moving conveyor 40. That airflow stream force provided by the blower system 46 is sufficient to lift the fabric pieces 32 from conveyor 40 and into the air. While the metal pieces 30 are sitting on the conveyor 40 through their weight and gravity to be conveyed into a collection bin 42 as illustrated in FIG. 3, the embodiment illustrated in FIG. 3A incorporates the magnetic sections 44 that will magnetically attract various of the metal pieces 30 and hold them to the conveyor 40 for more efficient transfer of the metal pieces to collection bin 42 from conveyor 40. The magnetic attraction will help counteract the force of the airflow and keep further metal pieces on conveyor 40. In one embodiment, the magnetic sections 44 are appropriately incorporated into the length of the conveyor belt 45 in an appropriate manner. The sections 44 might be the same width of the belt and may have a length along the conveyor 40 around 2 feet per section 44 as noted.

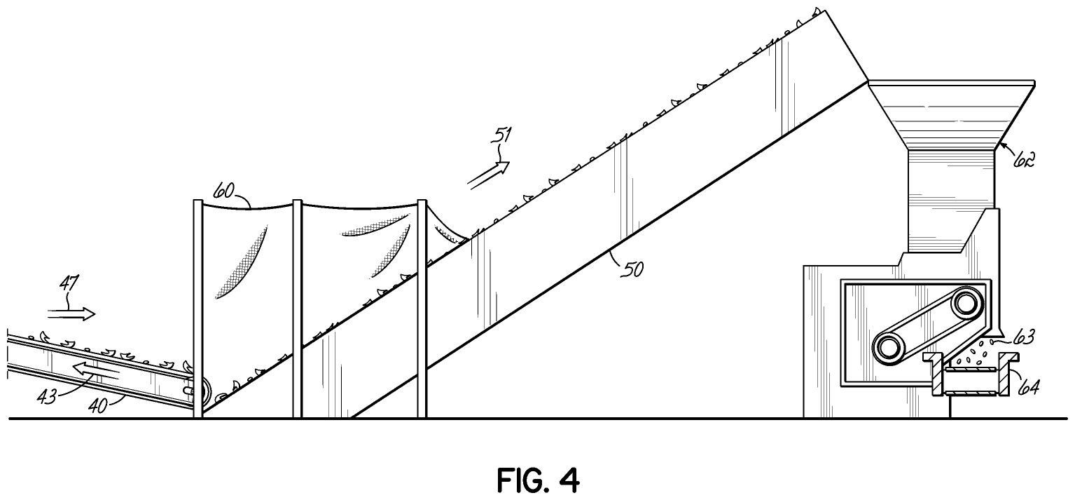

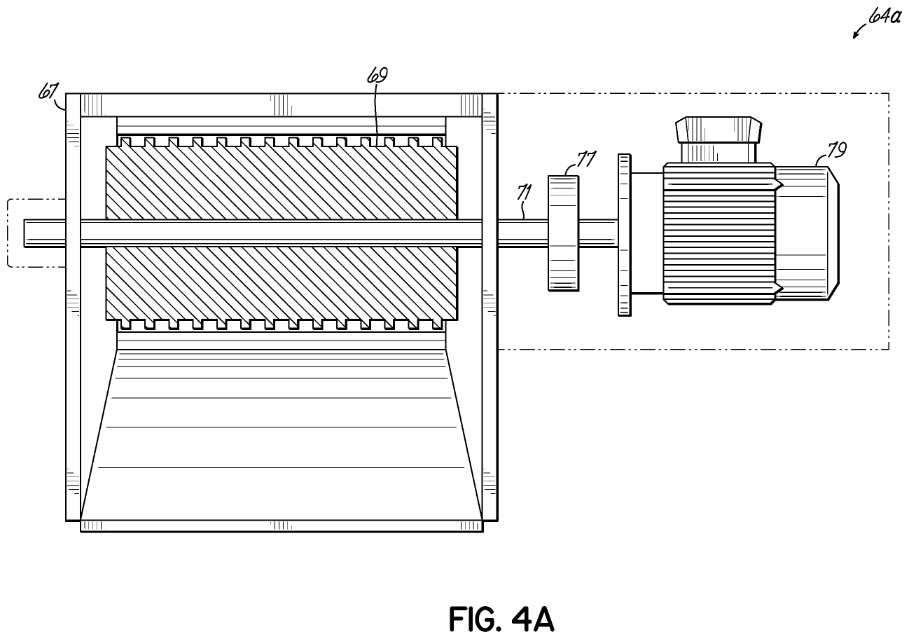

FIG. 4 illustrates conveyor 50 and its interface with conveyor 40. For capturing blown fabric pieces 32, a net 60 or other capture structure may be implemented on sides of the conveyor at an end of conveyor 50 proximate to its interface with conveyor 40 and the current of airflow 47 from blower system 46. The net 60 is configured for containing those blown fabric pieces and delivering the fabric pieces 32 efficiently onto conveyor 50. Conveyor 50 carries the pieces 30, 32 to the next stage, which is a secondary shredding station that includes a secondary shredder element 62 to further process and size the pieces 30, 32.

The secondary shredder element 62 is a suitable shredder for further shredding and reducing the sizing of the pieces 30, 32. In one embodiment, the shredder is a single axle rotor screened shredder. The secondary shredder element might be a shredder commercially available from Vecoplan of Archdale, North Carolina or WEIMA of Fort Mill, South Carolina. The secondary shredder element 62 provides a further shredding function to the material pieces 32 and to the remnant metal pieces 30 which were not captured in bin 42 and are delivered to the shredder element 62 via conveyor 50. The secondary shredder element incorporates a 42 inch wide and 52 inch long ram dimension with an abrasion resistant top plate. A 42 inch rotor interfaces with 54 fully supported, 40 millimeter, hardened rotor cutters that have a manganese hard facing application for abrasion resistance. The bed knives of the shredder are in 4 sections that are independently reversible and replaceable. The sizing screen is reversible carbon steel screen with 1.5 inch holes. The shredder housing provides a fully surrounded chamber with spring-loaded wipers for even wear. In one embodiment, the rotor runs at a speed of 130 rpm. The further shredded material, both fabric and metal, is reduced to around 1.5 inches generally at a rate of 1500 lbs/hour and dropped as pieces 63 for further processing depending on the post shred processing stages as illustrated and set forth further below.

In accordance with the invention, following the secondary shredding station, one or more magnetic separation stations or stages is used for further separating the materials as discussed below. The magnetic separation station using at least one magnetic element and motion of the materials with respect thereto for providing magnetic separation of metal pieces from the fabric or material pieces.

In one embodiment of the invention, the secondary shredder utilizes a design having an external bearing that is removed from the shredding chamber. The inventors have determined that the shredded material that is presented to the secondary shredder will sometimes migrate into an internal bearing of a shredder. Therefore, for the secondary shredder, an external bearing is preferred in one embodiment. Specifically, referring to FIG. 4A, the shredder 64a has a housing or hopper 67 with a shredder element/elements 69 rotating on an axle 71 inside the housing and driven by motor 79. To protect a bearing 77 of the axle 71 from metal wear of the shredded pieces, the bearing 77 is located externally from the housing 67 or a wall of the housing so that it is not exposed to the shredded metal.

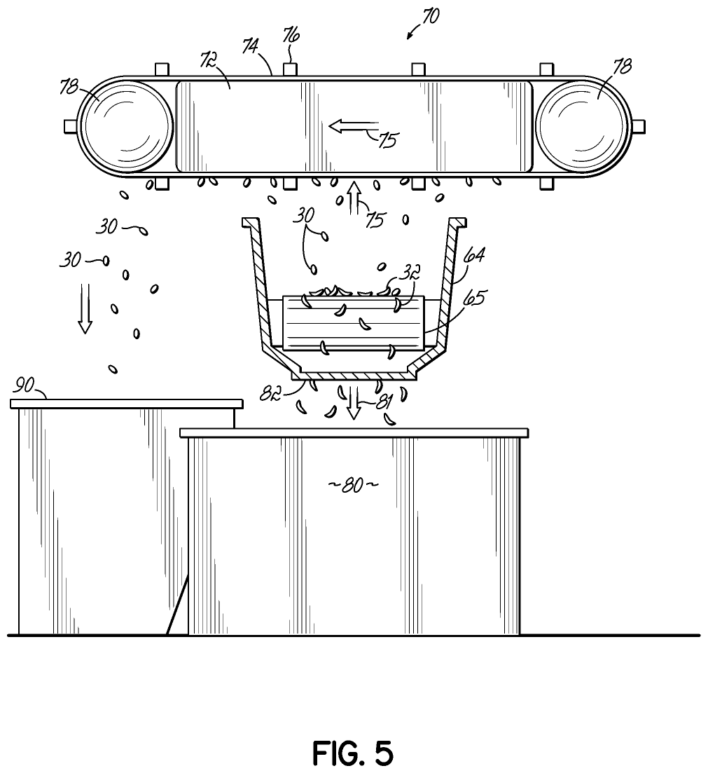

In one embodiment, as referenced in FIGS. 1 and 5, the shredded pieces drop onto another vibratory conveyor 64 where it is vibrated and conveyed in the direction of arrow 66 as shown in FIG. 1. The vibratory conveyor 64 has a length of around 20 ft and a width of 20 inches and provides a vibratory stroke of ⅝″ with a flow rate of around 45 feet/minute. Intercepting the vibratory conveyor 64 and the path 66 of the material pieces is a magnetic separation station 70 that includes magnet element 72 which is utilized with a cross-belt 65 to pull the metal pieces 30 away from the fabric pieces 32 on the vibratory conveyor 64 and direct the metal to a secondary bin 90. Specifically, referring to FIG. 5, the magnetic separation station 70 incorporates a large industrial magnet element 72, such as a magnet available from Erie Magnetics of Erie, PA. or Bunton Magnetics of Newton KS. Preferably, the magnet element 72 has a magnetic field strength in the range of 50-1500 Gauss. That magnetic force is sufficient to draw the shredded metal pieces 30 that are moving along vibratory conveyor 64 upwardly in the direction of arrow 75 toward the magnet element 72. The non-magnetic fabric pieces 32 remain on the surface of vibratory conveyor 64 as it is conveying the pieces. As illustrated in FIG. 1, the fabric pieces remaining on the vibratory conveyor 64 are carried by the conveyor in direction 66 to a collection bin 80 where they are collected and then may be further processed, such as in a further recycling step or a baling step. The material pieces collected in the collection bin 80 are generally mostly free of metal due to the unique processing provided by system 10 of the invention. The fabric pieces fall by gravity into a collection bin 80 as shown by arrow 81. For example, the pieces may drop through an opening at one end of conveyor 64 and into the collection bin 80. Collection bin 80 may also include a compression component such as a baler or ram (not shown) for compressing the material into more portable bales.

Referring again to the system embodied in one alternative as shown in FIG. 5, the magnetic separation station 70 includes one or more magnet elements 72 that are surrounded by a moving belt structure 74 having spaced ridges or cleats 76. As the metal pieces 30 are attracted to the magnet element 72, they are pulled against the belt structure 74. The belt structure and ridges 76 push magnetically attracted metal pieces 30 in the direction of the moving belt as illustrated by arrow 75. As shown in FIG. 1, the belt structure 74 and the orientation of the magnet elements 72 for the separation station are generally disposed at an angle perpendicular to conveyor 64 and the movement direction illustrated by arrow 66. The belt structure 74 and ridges 76 are moved at a speed of approximately 250-350 fpm. The metal pieces 30 are attracted by magnet elements 72 up to the surface of the belt structure 74 and proximate to the various cleats 76 of the moving belt. Therefore, as the belt structure moves over the magnet element(s) 72, the metal pieces are attracted against the belt surface and the movement of the belt structure and the cleats 76 push the metal pieces in the direction of arrow 75. The belt structure may be an endless belt traveling around axles or drums 78 positioned at each end. Due to the magnetic attraction and the movement of the belt 74, the metal pieces are flung away from the belt structure at its end and into another collection bin 90. Specifically, once the belt structure 74 leaves the end of the magnet elements 72, the force of the magnetic attraction of the metal pieces 30 toward the belt diminishes. As such, as the belt structure 74 and cleats 76 proceed over the end drum 78, the magnetic force holding the metal pieces 30 toward or against the belt diminishes sufficiently to allow the metal pieces to drop away or be flung from the belt structure into bin 90. More specifically, as illustrated in FIG. 5, the captured metal pieces 30 drop into the bin 90 where they are collected after the secondary shredding process. The metal pieces may then be further recycled as desired. Accordingly, the metal and fabric from recycled elements, such as a mattress, are provided as separate shredded metal pieces and shredded fabric pieces when the recycled element passes through the inventive system 10. Other alternative post-shred separation stages may be used as discussed further herein.

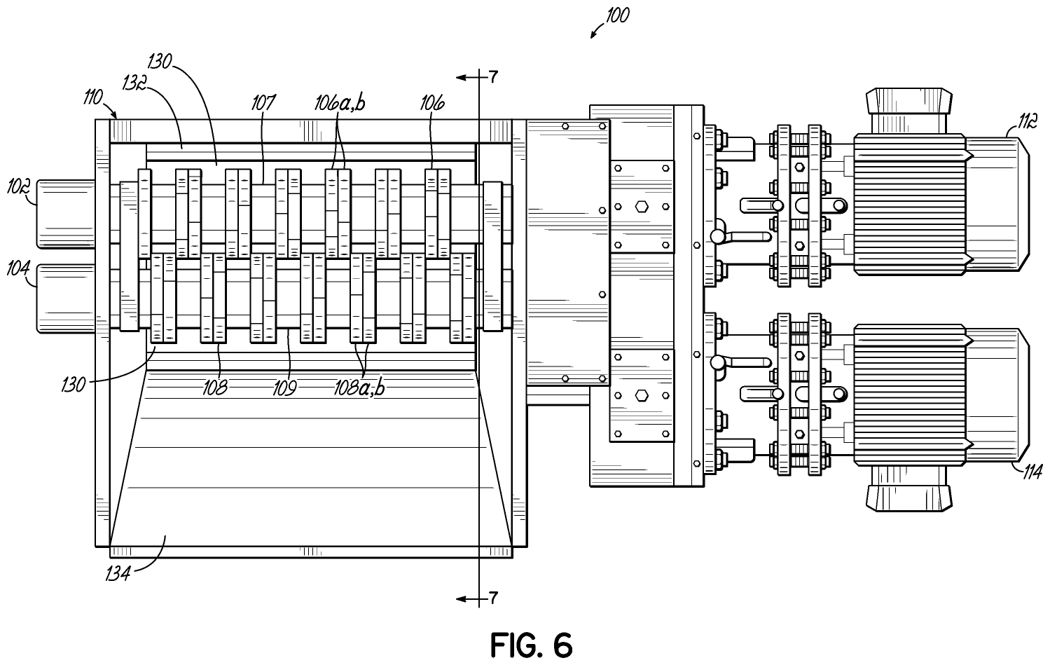

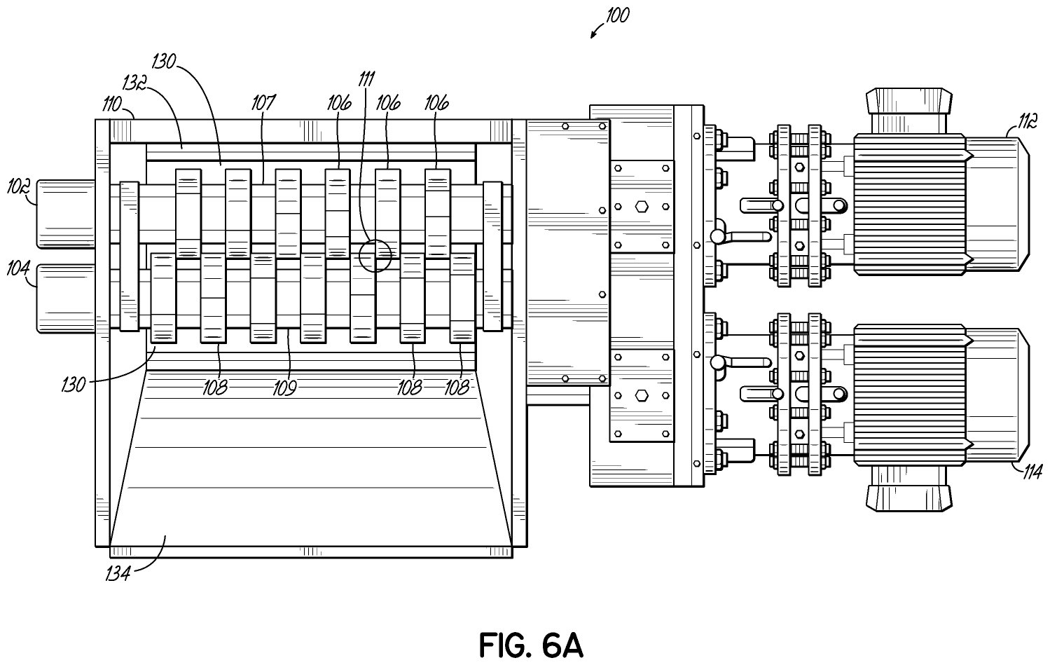

FIG. 6 illustrates an exemplary primary shredder mechanism 100 that may be utilized to provide the primary shredder element 20 for the systems 10-10e as described herein. The shredder mechanism 100 incorporates a modified industrial single pass, dual-shaft shredder specifically configured and designed for shredding elements incorporating both metal and fabric material such as mattress spring elements, in accordance with the invention. The shredder mechanism 100 operates a dual shaft design wherein two hexagonal shafts 102, 104 rotate a plurality of interlaced knives 106, 108 that are specifically and uniquely configured and arranged within a cutting chamber 110 for receiving elements to be recycled and grinding and shredding and separating the components of the recycled elements.

In one embodiment of the invention, the shredder mechanism 100 is designed and uniquely configured based on an industrial shredder device, which is available from Shred-Tech of Cambridge, Ontario. The shredder mechanism incorporates dual hexagonal shafts 102 and 104 that are 4 5/16 inches across the flats that are driven by appropriate motors 112 and 114. In one embodiment, the motors are 40 horsepower (HP) driving blades or knives 106, 108 having a general diameter of 12.5 inches. The cutting chamber of housing 100 may be 25×37 inches in one embodiment but may be sized up to 72 inches in length. The chamber has steel bulkhead walls 131 at its ends to protect bearings and seals associated with the motors 112, 114 and shafts 102, 104. As illustrated in FIG. 6, the knives 106, 108 are staggered along the shafts to interlace and thus cut or sheer the metal and fabric material that is being recycled. As discussed further hereinbelow, the knives having a unique configuration and spacing with respect to each other and within the cutting chamber 110 in order to provide specialty shredding. Specifically, the present invention is particularly effective for shredding mattress elements including fabric-covered coils.

Specifically, the knives have a nominal diameter of around 12.5 inches but can be in the diameter range or 8 to 25 inches. In one embodiment 54 knives 106, 108 are used and have a nominal thickness of around 17 millimeters (mm). But knives in the range of 17-50 mm might be used in the invention. In one embodiment, the primary shredder mechanism 100 of the invention uses a unique configuration of knives that are doubled up in thickness and positioned next to each other, thus increasing the effective overall thickness of the knives and the spacing between the pairs of double knives to allow for the interlacing movement and provide shredding while preventing the buildup of heat sufficient to melt the material of the fabric pieces. That is, each knife includes two side-by side knife portions to form one thicker knife. For example, two side-by-side 17 mm knives effectively form 34 mm knives with a desirable close spacing between the thicker knives. As seen in FIG. 6, multiple knife portions or pairs 106a, 106b and 108a, 108b operate together as a single knife unit adjacent to opposing pairs of knives on the opposite shaft. The thicker knives open up a wider space 109 between knives of the shredder to further prevent heat buildup and melting. The shafts are positioned and the knives are dimensioned so that the various cutting teeth of the double knives or unitary knives closely pass the cutting teeth of adjacent double knives/unitary knives for shredding the material. In an alternative embodiment of the primary shredder 100, as shown in FIG. 6A, single knives that are made as a unitary knife structure may be used having the desired wider thickness, such as 34 mm, and wider spacing as discussed in the disclosed example herein. In accordance with another feature of the invention, the shredding knives on one shaft are separated from the bypassing shredding knives on an opposing shaft by a distance below 0.010 inches. That is, the bypassing knives 106, 108 that are adjacent each other as opposing knives may implement a close separation distance or gap between the adjacent opposing knives as they pass to ensure proper shredding in accordance with the invention. In one embodiment, the spacing 111 between adjacent but opposing knives on respective opposing shafts is in the range of 0.005 to 0.015 inches. Preferably, the inventors have found that the optimum spacing is below 0.010 inches. More specifically, the spacing 111 is approximately 0.007 inches to ensure proper shredding.

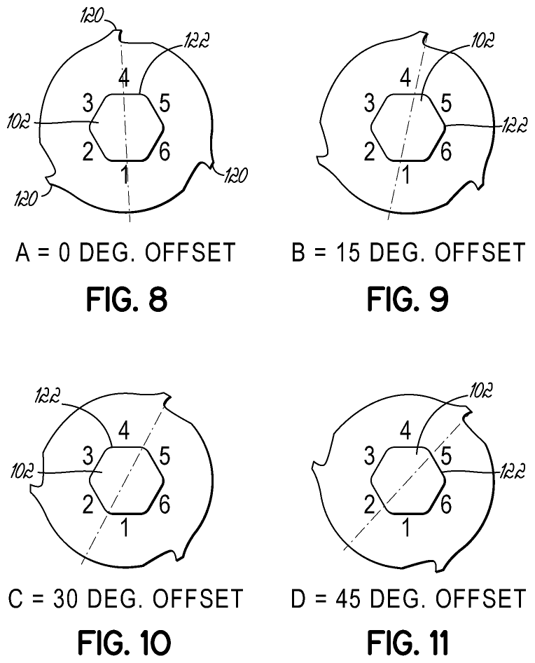

As illustrated in FIGS. 8-11, exemplary knives for use in the shredding mechanism 100 of the invention are illustrated as well as their arrangement on the respective shafts. Particularly, the knives have spaced teeth and in accordance with a feature of the invention, various knives on a shaft will have different orientations of teeth 120 around their circumference. The teeth will be offset differently with respect to multiple faces of the shaft. More specifically, the shaft 102 as illustrated in FIGS. 8-11 has a hexagonal cross-section and six faces which align with an hexagonal aperture 22 in each of the knives. The arrangement of the teeth 120 will have different offsets with respect to the shaft facets illustrated as numbers 1-6 in the figures. For example, as illustrated in FIG. 8, the knife teeth have what is considered a zero degree offset. Similarly, in FIG. 9, a 15 degree offset is illustrated while in FIGS. 10 and 11, 30 degree and 45 degree offsets respectively are shown. As illustrated in FIGS. 8-11, the different knives may be arranged next to each other with respect to different orientations around the hexagonal shaft so that together they provide a desired shredding arrangement. The knives in one embodiment may be 4140-4340 hardened heat treated steel with a hardness of 52-55 on the Rockwell scale. In alternative embodiments, knives having a Rockwell hardness from 40-68 might be implemented. For example, case hardened 8620 steel knives or cast knives having a hardness of 58-62 on the Rockwell scale may be used. Fabricated hard-facing knives, as well as 500 Brinell steel knives, having a hardness of 60 on the Rockwell scale, might also be used. Knives having a hardness of 58-62 on the Rockwell scale have been found to be desirable to achieve the results of the present invention.

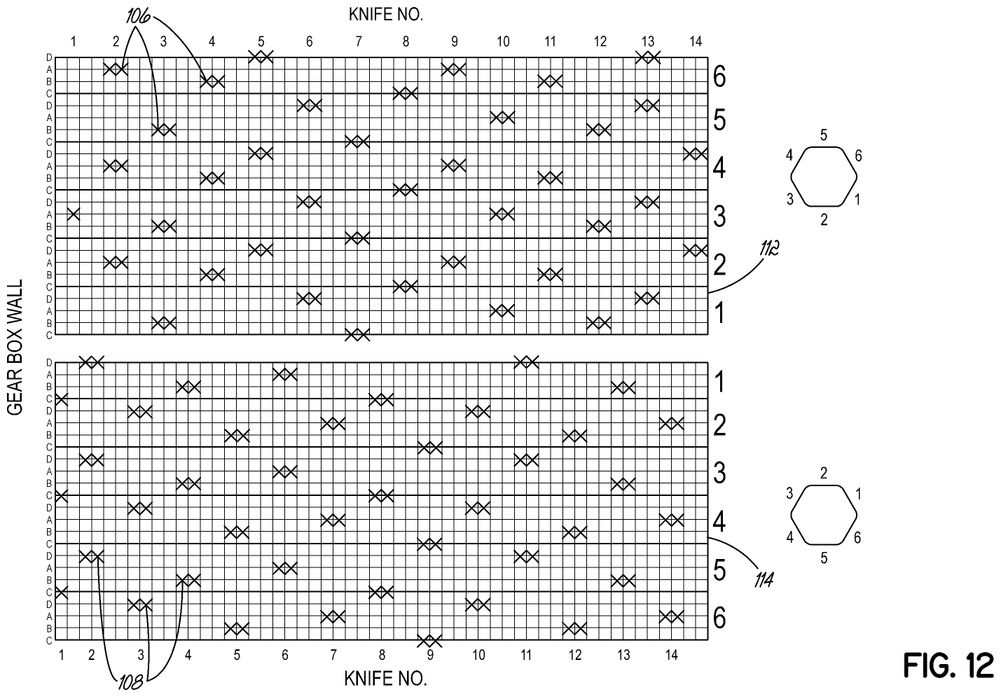

For example, referring to FIG. 12, an exemplary knife combination and arrangement pattern is shown for each of the shafts implemented in mechanism 100 for one embodiment of the invention. Other arrangements might be used, however. For each knife blade 1-14 as shown positioned along a respective shaft, it will have teeth at a certain position. FIG. 12 shows the selected offset pattern (A, D, C, D) for the teeth and is illustrated with the X's indicating the offset location of the teeth 120 on a knife (See FIGS. 8-11) and the position with respect to the various facets 1-6 of the shaft. Three teeth per knife are used but other combinations and knives with a lesser or greater number of teeth might be used. The pairs of knives are shown in FIG. 12 and the locations of the teeth in those pairs 106a, 106b and 108a, 108b. In single knife designs as shown in FIG. 6A, single teeth are implemented in the locations shown with XX's in FIG. 12. For example, the knife number 2 on the first shaft has the 3 teeth or sets of teeth in the A offset position, and they sit on the axle faces of 6 and 4 and 2. Alternatively, knife number 6 of the first shaft has the 3 teeth or sets of teeth in the D offset position, and they sit on the axle faces of 5 and 5 and 1. The example shown in FIG. 12 is not limiting but yields the desired shredding in accordance with one feature of the present invention.

The shafts may be coupled with appropriate gearing and to the motors 112, 114 to provide different speeds. In one example, the motors are 40 HP gear reduce motors. The shafts are powered and geared for different speeds with one shaft being a faster shaft and another being a slower shaft. For example, one shaft may operate faster at a range of 20-60 RPM while the opposing shaft may operate at a slower speed in the range of 10-50 RPM. In one embodiment, a fast/slow ratio might be 41/34 RPM. This provides a suitable speed and sheer force for cutting and shredding the metal and fabric in accordance with the inventive system 10. In one exemplary embodiment, the knife tip cutting force is around 54000 pounds per foot (lb/ft), but may be in the range of 30,000 to 80,000 (lb/ft).

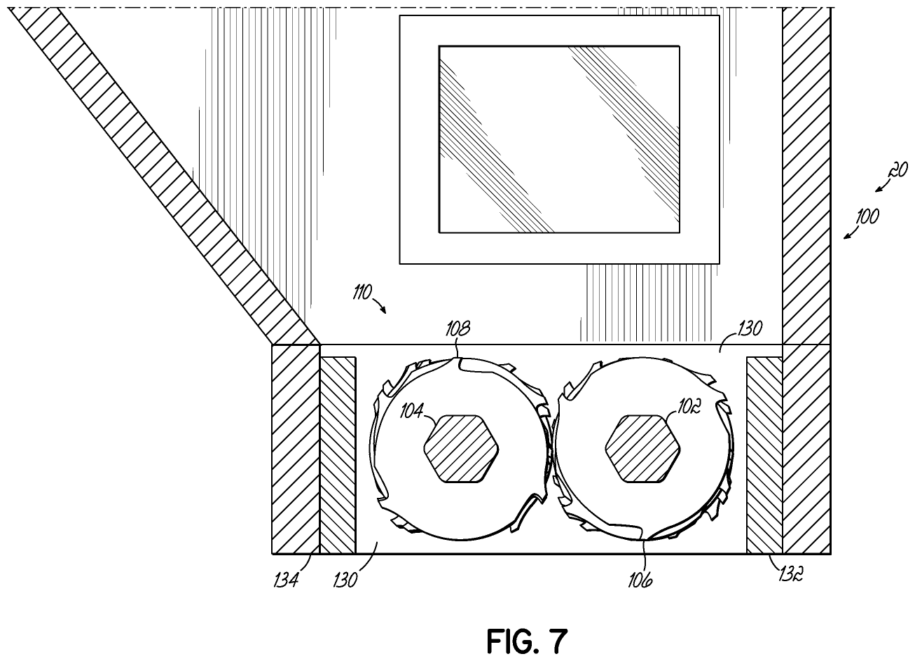

Referring to FIGS. 6, 6A and 7, in accordance with another aspect of the present invention, the shafts of the shredder mechanism 100 extend along sidewalls 132, 134. The inventive shredder mechanism 100 creates open space 130 between the shafts 102, 104 and the knives 106, 108 and the sidewalls 132, 134 of the cutting chamber 110. It is significantly important for the knives to travel freely not be interfered by or with respect to the sidewalls 132, 134 of the cutting chamber 110. That is, the primary shredder mechanism 100 of the invention incorporates no stationary structures to engage between the knives and the shafts at the sidewalls 132, 134. That is, the knives are free to rotate at the sidewalls. This presents a significant departure from existing shredding technology that has mechanisms on the sidewalls for cleaning the knives. That is, in accordance with a feature of the invention, no cleanout fingers or other stationary mechanisms are implemented at the sidewalls to extend in between the knives on the outsides of the knives and shafts when they are proximate to the cutting chamber sidewalls 132, 134. As discussed, the fabric material that is often recycled and shredded is plastic. As such, the melting of such plastic using existing shredder technology has been a significant problem in the recycling of pocketed coil mattresses. In accordance with the invention, this free knife construction as disclosed with the chamber 110 having no stationary elements against the knives at the sidewalls 132, 134 and a free open space between the knives and sidewalls, as well as the combination of wider knife blades and wider spacing between adjacent knife blades on the shaft and the closer spacing between adjacent interacting knife blades on the opposite shafts, provides an improved shredding function. The invention prevents the metal and fabric materials from becoming trapped between the cutting knives and between the shaft and the sidewalls of the cutting chamber and maintains a flow in the shred without building up sufficient heat and melting the fabric material that is shredded and moving in the knives. That is, the combination of the blade arrangements 106, 108, or pairs 106a, 106b and 108a, 108b and the wider spacing gaps 107, 109 between the knives as well as free spaces 130 with no stationary structure between the sidewalls 132, 134 and the knives and the closeness of opposite blades 106, 108 creates a unique shredding arrangement that is able to handle the metal and fabric at an increased speed and throughput without jamming, clogging, and overheating the shredder mechanism 100 in the shredding function.

As noted, in one embodiment of the invention, two blades having different offsets are positioned next to each other to provide the increased width and spacing and unique arrangement of the invention. Alternatively, a single blade as shown in FIG. 6A might be constructed to have the desired width or thickness, teeth arrangements and spacing along the hexagonal shaft facets that is achieved by bringing two thinner blades together. Such an arrangement would still provide a desirable blade configuration and teeth offset while providing the desirable spacing 107, 109 between the knife blades and the free space 130 with respect to chamber sidewalls to achieve the desired shredding function.

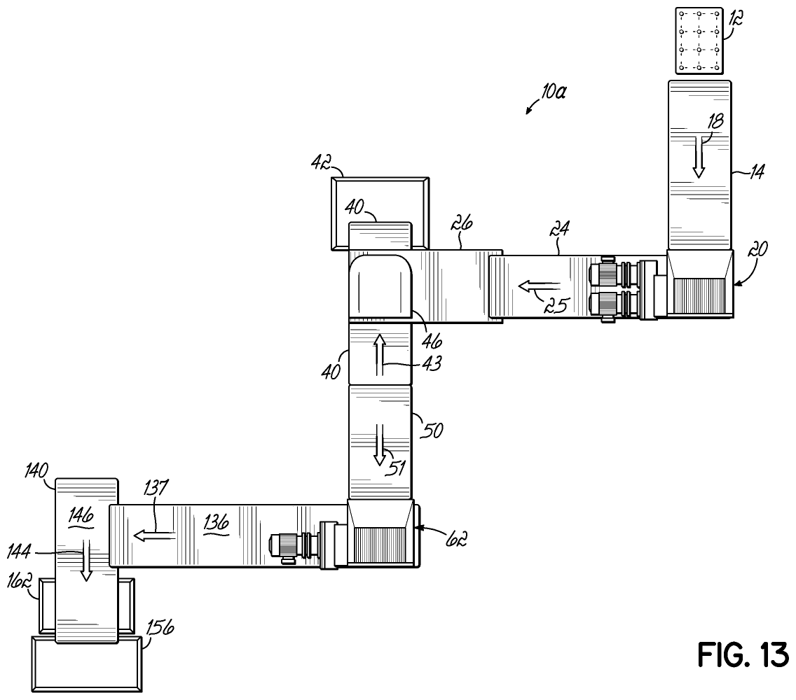

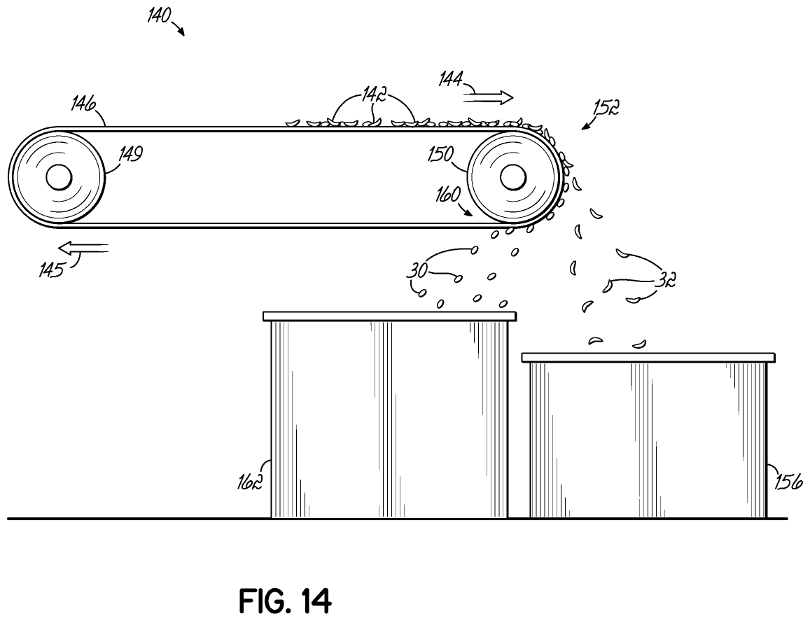

While the system of FIG. 1 might provide desirable segregation of the material and metal pieces, alternative or further separation or segregation stages might be desired of the separated material pieces. To that end, one or more additional or alternative separation stages might be implemented. FIGS. 13-15 illustrate an alternative embodiment of the invention that uses an additional separation stage. Specifically, the system 10a incorporates an alternative magnetic separation station that follows the secondary shredder element 62 that is used for further shredding and sizing the pieces 30, 32. For example, the additional separation station might be used as a final processing station/step for the separation of the materials. More specifically, referring to FIGS. 13-15, the elements in system 10a that are common with elements of system 10 of FIG. 1 share common reference numerals and will generally operate as described herein. In one embodiment, following the shredder element 62 and any subsequent separation processing, a further or possibly final stage might be provided for separation to create a supply of clean material. Material from the shredder element 62 is conveyed by conveyor 136 in the direction of arrow 137 to another conveyor 140. The further shredded material 142, both fabric pieces 32 and metal pieces 30, is dropped onto the conveyor 140 where it is conveyed in the direction of arrow 144 as shown in FIGS. 13 and 14. In accordance with the alternative embodiment, the conveyor 140 incorporates a belt 146 that is driven over rollers 149 and 150. One or more of the rollers may be appropriately powered to rotate and move the belt 146 in the direction of arrows 144. The roller 150 is a magnetic pulley or roller that is magnetized, such as by being made of a permanent magnetic material or alternatively by being electrically magnetized as would be understood by a person of ordinary skill in the art. The ends of the belt 146 pass over the rollers 149, 150 as the belt moves. As the further shredded metal and fabric material 142 progresses along conveyor 140 in direction 144, the material 142 encounters the magnetic roller 150 as the belt 146 passes over the roller at the discharge end 152 of the conveyor 140.

The magnetic roller 150 magnetizes the belt 146 at its discharge end 152. That is, the magnetic field and forces of the roller 150 attract the metal of the material 142 through the belt 146. The metal pieces 30 will be magnetically drawn to the belt and held on the belt as it passes over the magnetic roller 150. The fabric or other non-metallic pieces 32 will not be attracted by the roller 150 or held to the belt at the discharge end. Rather, when the belt 146 passes over roller 150 at the discharge end 152 and begins its passage in the opposite direction, the fabric pieces 32 are slung by momentum or will fall by gravity off of the belt 146 and away from the metal pieces. To that end, a bin or collector container 156 may be implemented at the discharge end 152 of the belt to capture fabric pieces 32.

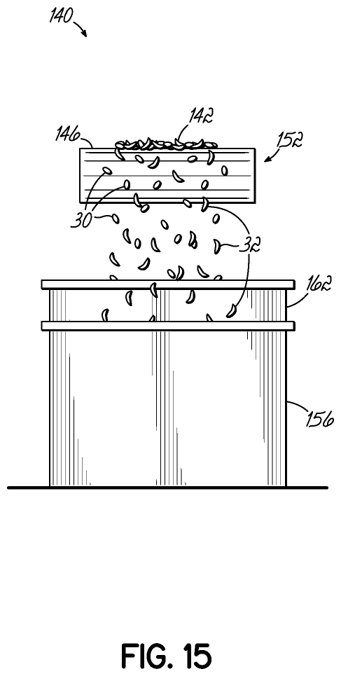

The metal pieces 32 stay attracted to the belt 146 around the magnetic roller 150 which engages the belt 146, near the discharge end, at both the top side of the conveyor 140 and the bottom side. That is, as the end portion of the belt 146 wraps around the magnetic roller 150, the metal pieces are held to the belt until it separates from the roller 150 on the return of the belt on the bottom side in the direction of arrow 145. (See FIGS. 14, 15). The roller will actually hold the metal pieces 30 to the belt slightly past the discharge end and along the return belt path (arrow 145) along the bottom side of the conveyor 140. Then, when the belt 146 separates from the magnetic roller 150, generally in the area 160 at its bottom side return path, the magnetic field of the roller 150 and its effect on the belt and metal pieces 30 diminishes and drops off so as to no longer attract the metal pieces 30. The metal pieces 30 then separate from the belt. Through the momentum of travel of the belt over magnetic roller and the conveyance of the metal pieces, the metal pieces 30 are flung or fall from the belt. Similarly, a bin or collector container 162 may be implemented at the discharge end 152 to capture metal pieces 30. Because the metal pieces 30 are held to the belt longer than the fabric pieces 32, the bin 156 sits forwardly of the bin 162 at the discharge end. (See FIG. 15). In that way, the further shredded pieces 142 are further separated and captured.

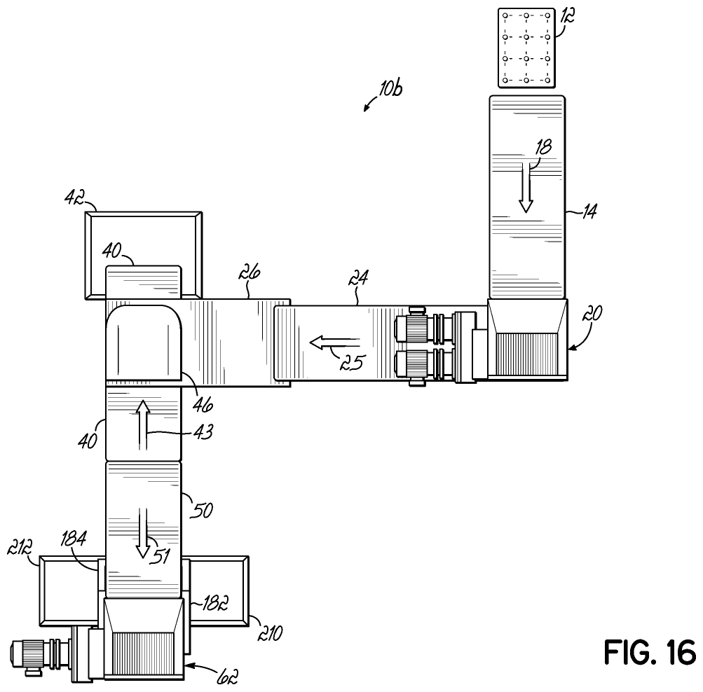

While the stage as shown in FIG. 13 might provide some further separation, and might be used with the system of FIG. 1, it may be desirable to provide more vigorous separation using one or more additional separation stages that are used in addition to or alternatively to the system in FIG. 1. FIGS. 16-18 illustrate another alternative embodiment of the invention. Specifically, the system 10b incorporates additional magnetic separation stations/steps that follow the secondary shredder element 62 that is used for further shredding and sizing the pieces 30, 32. In one embodiment, the additional separation stations may complete the process. In still another embodiment, the additional stations following the secondary shredder may be combined with or followed by one or more final separation stations/steps. For example, the conveyor 140 of FIG. 13 and its operational features may be added to the system 10b of FIG. 16 in order to provide further processing as described herein.

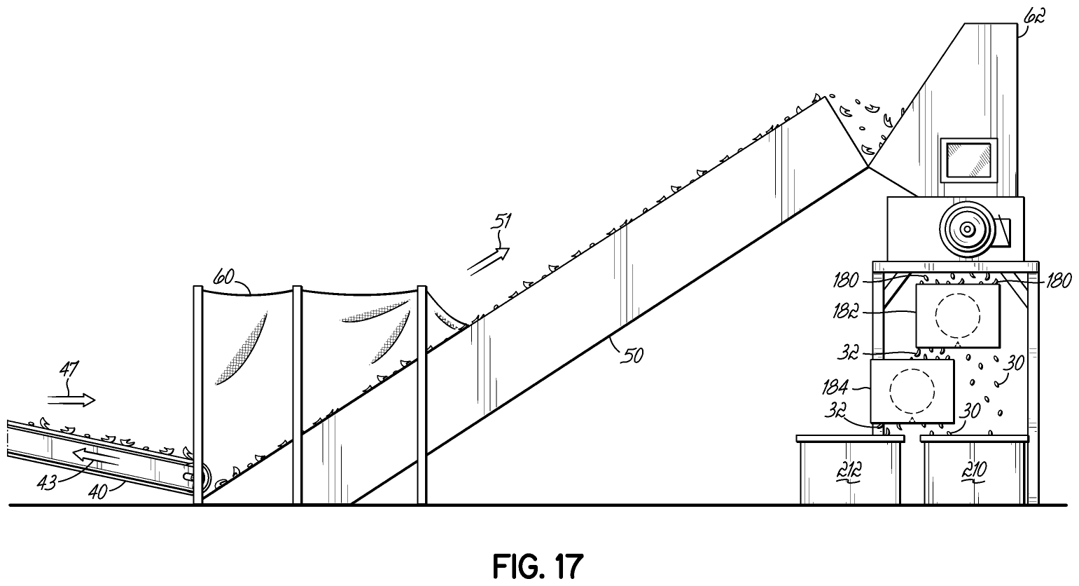

More specifically, referring to FIGS. 16-18, the elements in system 10b that are common with the elements in system 10 of FIG. 1 share common reference numerals and will generally operate as described herein. In the system 10b, the material might be directed to a magnetic separation station that includes one or more magnetic drum separating systems or stages for further separation. In the embodiment of FIG. 16, the secondary shredder is followed by a further separating stage. Specifically, the material 180 drops vertically into one or more magnetic drum separating systems for further separation using magnetic fields and forces. Specifically referring to FIG. 17, the material travels on conveyor 50 to the secondary shredder element 62. The output material 180 from shredder element 62 falls into a magnetic drum separator 182. In the illustrated embodiment, a second magnetic drum separator 184 captures the output from the separator 182. The present invention is not limited to the number or magnetic drum separating systems that may be serially implemented to provide the material separation, although the illustrated system uses two for illustrative purposes. Although the FIGS. 16-18 illustrate the output of the secondary shredding station falling into the first magnetic drum separator, the output of the secondary shredding station might also be conveyed to the first magnetic drum separator.

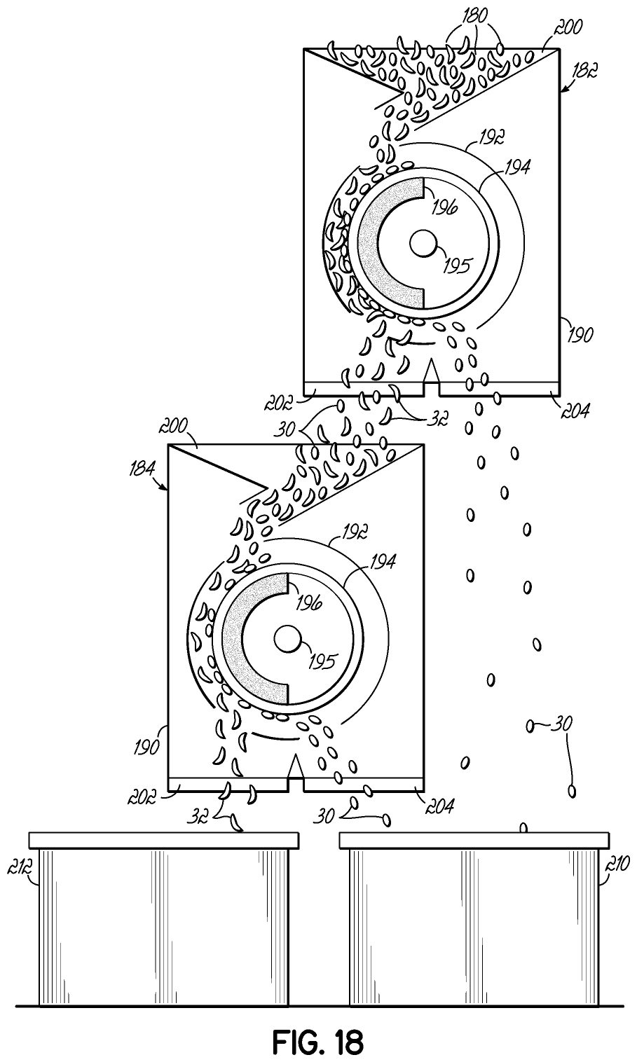

Each magnetic drum separator 182, 184 incorporates a separation step for separating the metal pieces 30 and the fabric or non-metallic material. Specifically, referring to FIG. 18, the magnetic drum separators 182, 184 each have a housing 190 containing a magnetic separator 192. The separator 192 includes a drum or shell 194 that revolves around an axis 195 and around a fixed magnetic field. The fixed magnetic field is provided by a fixed permanent magnetic assembly that includes a permanent magnet 196 that is positioned around axis 195 for creating the magnetic field over which the shell 194 rotates. The permanent magnet 196 may be configured to extend around the axis for some percentage of the circumference of the shell to induce a field to facilitate the material separation efficiently. In one embodiment, the drum magnets might be available from A&A Magnetics of Woodstock, Illinois. The drum magnets might include ceramic magnets of different sizes depending on the separation stage. For example, magnets may be 18 inches in diameter with a 42 inch width, or 12 inches in diameter with a 42 inch width, or 12 inches in diameter with a 24 inch width. In one embodiment, the magnet 196 might extend approximately 150 degrees around a circumference of cylindrical shell or drum. Generally, permanent magnet 196 is configured to extend around the axis around 50% of the circumference of the shell. The magnetic drum separators 182, 184 each include an input chute or opening 200 for receiving the discharge 180 from secondary shredder element 62 or other previous stage. They also include one or more output or discharge chutes for the separated material. In the illustrated embodiment, one output chute 204 provides an output path for the metal pieces 30 or other non-metallic material whereas chute 202 provides an output path for the fabric pieces 32.

The In operation, the shredded material 180 drops from the secondary shredder element 62 into chute 200. As it falls inside of the housing 190 it encounters the rotating shell 194 and adjacent magnetic field from the permanent magnet 196. The housing and chute may be configured for directing the material 180 toward a side of the shell 194 that experiences the magnetic field. In that way, as shown in FIG. 18, the material is affected by the magnetic field as the shell 194 rotates and primarily the metal pieces 30 are magnetically pulled to and held against the shell while the other pieces 32 (that may include some metal pieces 30) are free to fall and drop to an output chute 202. The metal pieces 30 adhere or are held magnetically to the shell as it rotates around the fixed magnetic field of the magnet and moves toward the chute 204. The non-metallic pieces flow off of the drum with gravity in a normal trajectory. Once the portion of the shell that has the metal pieces attracted thereto passes proximate chute 204, the shell and pieces move away from the fixed magnet 196. Proximate to the chute 204, the extent of the field from the permanent magnet 196 may terminate, such that further travel of the shell 194 with the metal pieces 30 attracted thereto will move beyond the effects of the magnet 196 and magnetic field forces and the metal pieces 30 are then free to drop away from the shell and through the chute 204. A bin 210 or other catch area may be used to catch the metal pieces 30. As shown, the material pieces 32 and some of the non-attracted metal pieces 30 are free to fall from the shell 194 by gravity and drop into chute 202. In that way, the pieces 30, 32 are further separated or segregated. As may be appreciated, the output of magnetic drum separator 182 through chute 202 may still contain some metal within the material pieces 32.

In one embodiment, the output of chute 202 might be directed to a catch area or basin for the material pieces 32. However, in accordance with another embodiment of the invention, one or more additional magnetic drum separators may be used. In the illustrated embodiment, another magnetic drum separator captures the output from chute 202 of the magnetic drum separator 182. The material and metal pieces from output chute 202 may feed into the input chute 200 of magnetic drum separator 184. Therein, the input stream is again separated magnetically and dynamically as disclosed herein to present multiple output streams from chutes 202 and 204 of the separator 184. In that regard, the output from chute 204 and metal pieces 30 might feed into a catch area or bin 210. The serial magnetic drum separator stages and housings are staggered in alignment as necessary for the output of one separator stage to flow to another stage, while the output of the final stage flows to align with collection areas or bins. As noted, the output of the chute 204 of the magnetic drum separator 184 flows into bin 210, whereas the output flow of chute 202 of material pieces 32 flows into another area or bin 212 for collecting the metal pieces.

The stages 182, 184 might be the end of the processing stages and the material pieces 32 might be bailed or otherwise manipulated, while the metal pieces at various bins or locations are 30 are processed and recycled. Alternatively, as noted herein, further separation and segregating of the output of the separators 182, 184 might occur. For example, the additional stage as illustrated in FIGS. 13-15 might be implemented following the output of the separators 182, 184 for further cleaning the material from any metals before the processing ceases.

The embodiment of FIGS. 16-18 incorporates serial, vertically positioned magnetic drum separators that are fed one to the other. This will require some level of vertical spacing or elevation for the secondary shredder element for such positioning. In alternative designs, if such vertical positioning of a secondary shredder element is not available, a single magnetic drum separator might be implemented below the shredder element and then the output of that magnetic drum separator might be conveyed up to one or more additional magnetic drum separators.

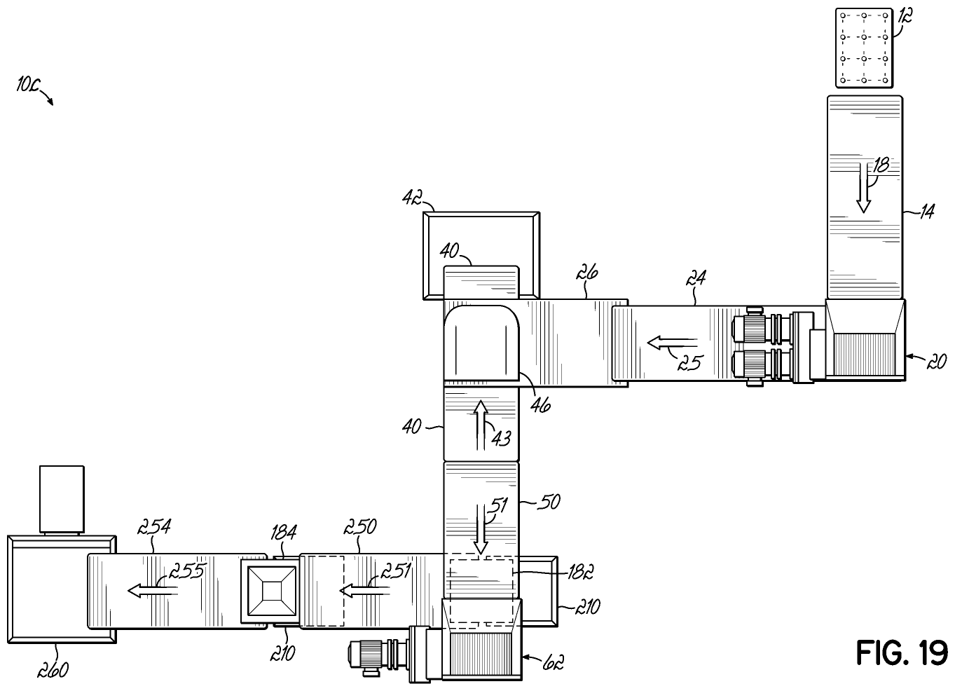

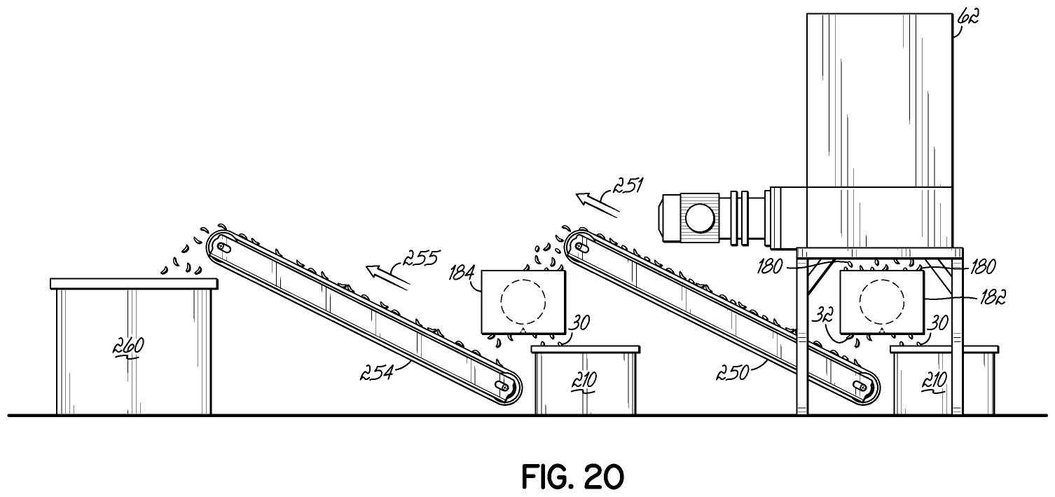

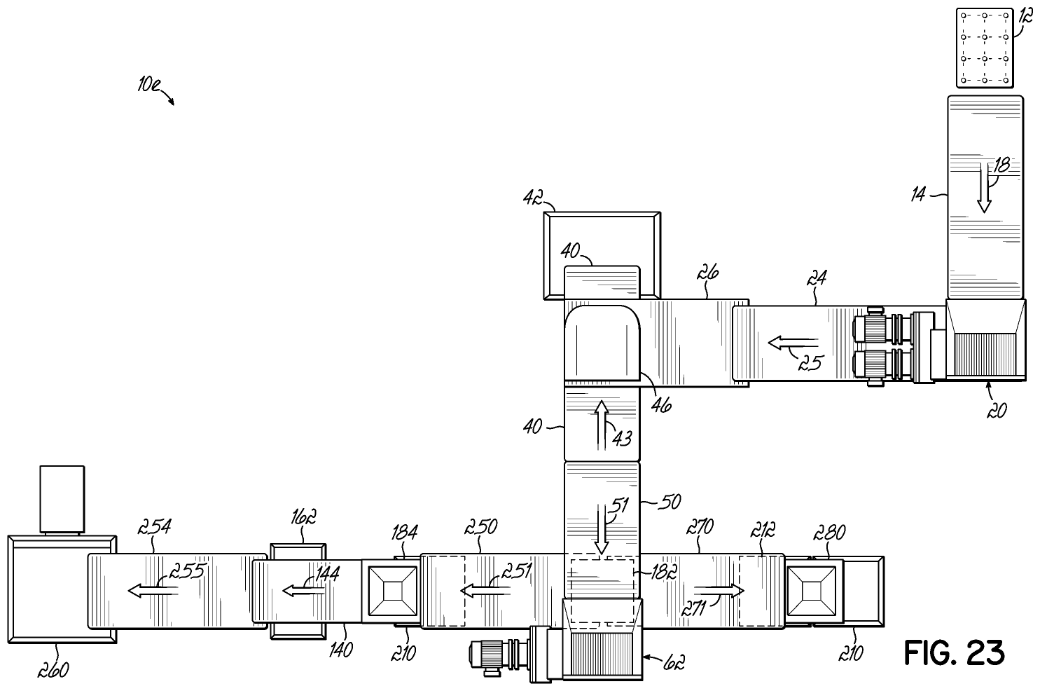

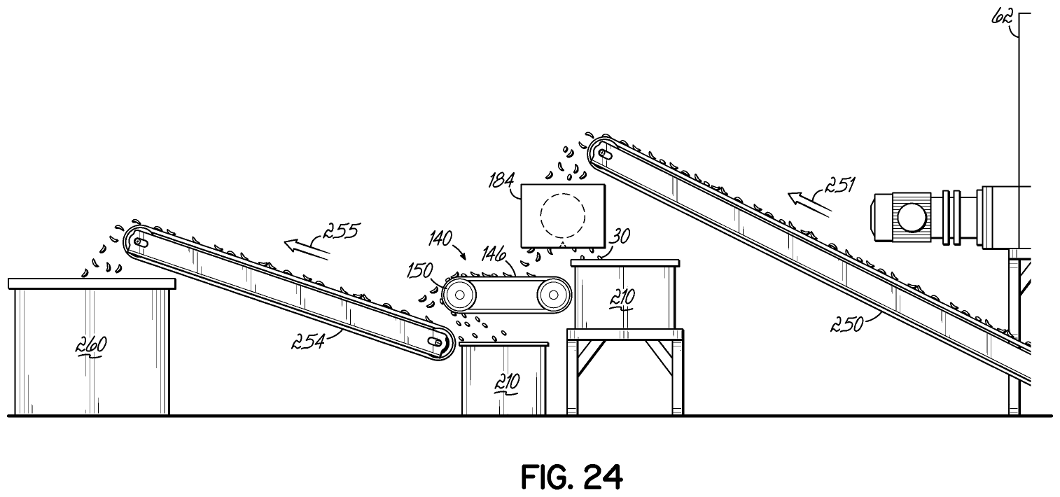

FIGS. 19-20 illustrate another alternative system of the invention that is an alternative to the system of FIGS. 16-18, for example. Accordingly, the reference numerals for similar elements or components are utilized as appropriate. Specifically, the system 10c shows the secondary shredder 62 implemented with magnetic separation stations/steps that follow the secondary shredder element 62 that is used for further shredding and sizing the pieces 30, 32. Again, in one embodiment of the system of FIGS. 19-20, the additional separation stations may complete the process. In another embodiment, the additional stations following the secondary shredder may be followed by one or more final separation stations/steps. For example, the conveyor 140 and its operational features may be added to the system 10c of FIG. 19 in order to provide further processing as described herein (e.g. see FIGS. 23-24).

Referring to FIG. 19, the material output of shredder 62 might be directed to one or more magnetic drum separating systems for further separation. In the embodiment of FIGS. 19-20, the output material 180 from shredder element 62 falls into a magnetic drum separator 182 for further separation using magnetic fields and forces. The magnetic drum separator 182 operates as discussed with respect FIG. 18 and has an output chute 204 that provides an output path for what is predominantly the metal pieces 30 (but may be mixed in with other non-metallic material), whereas chute 202 provides an output path for the fabric pieces 32 that may still incorporate some combination of metal and non-metallic material. The metal pieces of chute 204 may drop into a bin 210 or other catch area that may be used to catch the metal pieces 30. As shown, the material pieces 32 and some of the non-attracted metal pieces 30 are free to fall by gravity and drop into a respective chute 202.

However, rather than dropping into a second magnetic drum separator 184 that sits vertically below separator 182, the system 10c of FIG. 19 may be confined such that there is not sufficient vertical room below for a second magnetic drum separator 184. Therefore, a conveyor element 250, such as one using a conveyor belt as discussed herein, might capture the materials 30, 32 from chute 202 and convey it in the direction of arrow 251 to a second magnetic drum separator 184, that is positioned away from the first magnetic drum separator 182. In one embodiment, the conveyor element may be inclined up to the top of the second magnetic drum separator 184 as illustrated in FIG. 20. Therein, the metal material and non-metallic material might be further segregated and the metal material 30 delivered to a bin 210 or other holding area. The remaining material, such as from the chute 202 (see FIG. 18) of separator 184, might be conveyed in the direction 255 by a conveyor element 254 to a bin or a baler 260, wherein the predominantly non-metallic material is baled or otherwise processed for shipping.

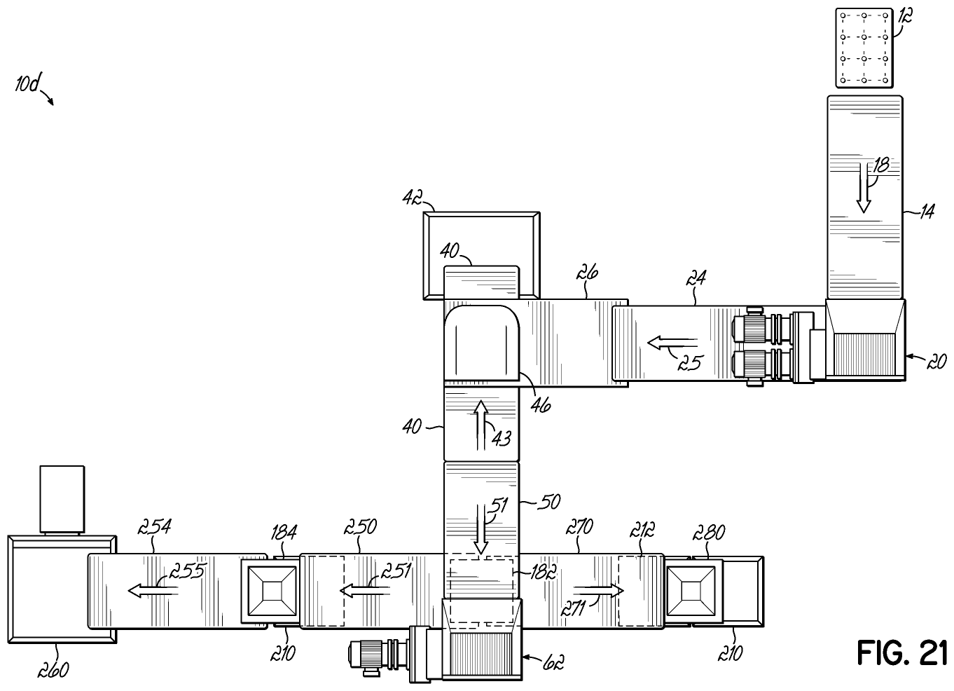

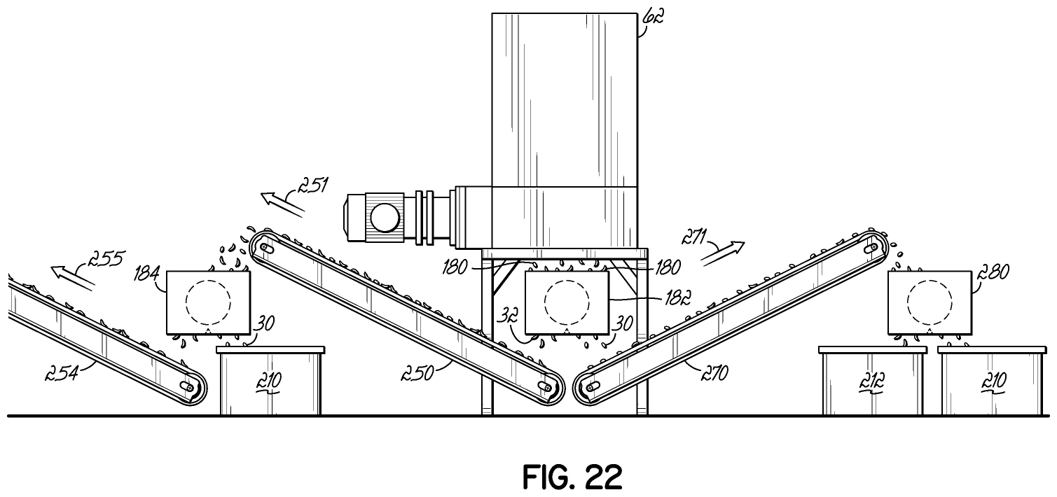

FIGS. 21-22 illustrate a further alternative embodiment of the invention. System 10d and elements therein might be implemented if it is desirable to further clear the primarily metal pieces 30 and output of the chute 204 of separator 182 of any non-metallic fabric material (See FIG. 18). For example, the generally metal output 30 of the initial separator stage 182 might go through its own additional magnetic drum separator stage, just as the non-metallic/metal discharge output proceeds to the magnetic drum separator 184. Specifically, referring to FIG. 21, the metal output of magnetic drum separator 182 that might normally be captured in a bin 210 or other container as shown in FIGS. 19-20, might further be processed. As shown in FIGS. 21-22, the generally metal material 30, that would be the output of the chute 204 of magnetic drum separator 182 is directed to a conveyor element 270 to be conveyed and proceed in the direction of arrow 271 to another magnetic drum separator 280. Therein, the metal material pieces are further separated or cleaned. As shown in FIG. 22, the conveyor element 270 might be elevated so the output of magnetic drum separator 182 drops into the input chute of the magnetic drum separator 280 that would operate as shown and discussed with respect to FIG. 18. The output of the magnetic drum separator 280 may then be directed into various catch containers 210, 212 that are placed at the output chutes 202, 204 of the magnetic drum separator 280.

As earlier noted, the present invention is not limited to the number or magnetic drum separating systems that may be serially implemented to provide the desired material separation, although the illustrated system uses two and three such stages for illustrative purposes.

As earlier noted, the stages 182, 184, might be the end of the processing stages for creating the predominantly non-metallic and material pieces 32, that might be bailed or otherwise manipulated and processed. However, as noted herein, further separation and segregating of the non-metallic output of the separators 182, 184 might occur. For example, the additional stage as illustrated in FIGS. 13-15 might be implemented following the output of the separators 182, 184 for further cleaning the material from any metals. Further referring to FIGS. 23-24, an alternative system 10e is illustrated using an interim stage that resembles the stage disclosed with respect to FIGS. 13-15, such as before the non-metallic material is baled.

FIGS. 23-24 show a system resembling the system of FIGS. 21-22 that uses the stage 140 as an interim stage. Accordingly, similar reference numerals are used, as appropriate, for previously discussed and disclosed stages and elements. As shown in FIG. 23, an additional magnetic separation station follows the secondary shredder element 62 and magnetic drum separator stages 182, 184 for the purposes of further cleaning the non-metallic material before it is baled or otherwise processed. Material from the magnetic drum separator 184 is dropped onto the conveyor 140 where it is conveyed in the direction of arrow 144 as shown in FIGS. 23 and 24. The conveyor 140 incorporates a belt 146 that is driven over rollers similar to FIG. 14.

One or more of the rollers may be appropriately powered to rotate and move the belt in the direction of arrows 144. The roller 150 is a magnetic pulley or roller that is magnetized, such as by being made of a permanent magnetic material or alternatively by being electrically magnetized, as would be understood by a person of ordinary skill in the art. The ends of the belt 146 pass over the roller 150 as the belt moves. As the further shredded metal and fabric material progresses along conveyor 140 in direction 144, the material encounters the magnetic roller 150 as the belt 146 passes over the roller at the discharge end of the conveyor 140.

The metal pieces 30 will be magnetically attracted to or drawn to the belt and held on the belt as it passes over the magnetic roller 150. The fabric or other non-metallic pieces 32 will not be attracted by the roller 150 or held to the belt at the discharge end. Rather, when the belt 146 passes over roller 150 the fabric pieces 32 are slung by momentum or will fall by gravity off of the belt 146. To that end, a bin or collector container 210 may be implemented at the discharge end 152 to metal pieces 30. The remaining, and further cleaned or segregated, non-metallic material is then conveyed on conveyor 254 to a bailer 260 or other bin.

As will be appreciated, the direction and location of various of the elements, including conveyor elements, of the numerous stages shown in the figures is not limiting to the invention. The direction in which the longer conveyor elements will be oriented will often depend on the floor space that might be available for installation. Therefore, the layouts might vary while incorporating the various stages of the inventive system. Furthermore, the various magnetic separation stages following the secondary shredder may be considered modules that can be mixed and serially arranged for separation of the pieces 30, 32. So a particular order or orientation is not limiting to the present invention.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A system for recycling pocketed metal coil mattresses comprising:
a primary shredding station, the primary shredding station implementing a primary shredder element having a housing with opposing shafts mounted to extend along sidewalls of the housing, each shaft including a plurality of opposing shredding knives configured to bypass each other for shredding materials in the housing into metal and fabric pieces;
the knives each having a thickness in the range of 17-50 mm;
the knives of each respective opposing shaft being spaced apart from each other along the respective shaft in the range of 17-50 mm;
the primary shredder element being free of stationary elements in the spaces between the shredding knives at the sidewalls;
a motion separation station utilizing motion of the fabric pieces and the metal pieces for separating the pieces following the primary shredder station;
an air separation station providing an airflow to separate fabric pieces from the metal pieces; and
a secondary shredding station for further shredding the material.

2. The system of claim 1 further comprising:
a magnetic separation station, following the secondary shredding station, the magnetic separation station using at least one magnetic element to separate fabric pieces from the metal pieces.

3. The system of claim 1 wherein the shredding knives on one shaft are separated from the bypassing shredding knives on an opposing shaft by a distance below 0.010 inches.

4. The system of claim 1 wherein the motion separation station includes a vibratory conveyor for vibrating the fabric pieces and the metal pieces for separating the pieces prior to the air separation station.

5. The system of claim 1 wherein the magnetic separation station includes, a magnetic drum separator following the secondary shredding station, the magnetic drum separator receiving material from the secondary shredding station in an input chute and rotating the fabric pieces and the metal pieces around a fixed magnetic field for separating the metal pieces from the fabric pieces into different discharge chutes.

6. The system of claim 5 wherein the magnetic separation station includes, a plurality of magnetic drum separators following the secondary shredding station, each magnetic drum separator rotating the fabric pieces and the metal pieces around a fixed magnetic field for separating the metal pieces from the fabric pieces into different discharge chutes, a discharge chute for the fabric pieces of one magnetic drum separator being directed to an input chute of another magnetic drum separator.

7. The system of claim 5 wherein the magnetic separation station includes a plurality of magnetic drum separators following the secondary shredding station, each magnetic drum separator rotating the fabric pieces and the metal pieces around a fixed magnetic field for separating the metal pieces from the fabric pieces into different discharge chutes, a discharge chute for the metal pieces of one magnetic drum separator being directed to an input chute of another magnetic drum separator.

8. The system of claim 5 wherein the magnetic separation station includes a plurality of magnetic drum separators following the secondary shredding station, each magnetic drum separator rotating the fabric pieces and the metal pieces around a fixed magnetic field for separating the metal pieces from the fabric pieces into different discharge chutes, a discharge chute for the metal pieces of a first magnetic drum separator being fed to an input chute of another magnetic drum separator and a discharge chute for the fabric pieces of the first magnetic drum separator being fed to an input chute of another magnetic drum separator.

9. The system of claim 1 wherein the magnetic separation station includes a belt passing over a magnetic roller following the secondary shredding station, the magnetic roller attracting metal pieces to the belt at an end of the belt to allow fabric pieces to fall away from the metal pieces at an end of the belt.

10. The system of claim 1 wherein the knives of the primary shredding station are formed by two side-by-side knife portions for forming one thicker knife having a thickness in the range of 17-50 mm.

11. A shredding station for recycling pocketed metal coil mattresses comprising:
a housing defining a cutting chamber and sidewalls;
a pair of opposing rotating shafts mounted to extend in the cutting chamber along sidewalls of the housing, each shaft including a plurality of opposing shredding knives configured to bypass each other for shredding materials in the housing into metal and fabric pieces;
the knives each having a thickness in the range of 17-50 mm; and
the primary shredder element being free of stationary elements in the spaces between the shredding knives at the sidewalls.

12. The shredding station of claim 11 further comprising:
the knives of each respective opposing shaft being spaced apart from each other along the respective shaft in the range of 17-50 mm.

13. The shredding station of claim 11 wherein the shredding knives on one shaft are separated from the bypassing shredding knives on an opposing shaft by a distance in the range of 0.005 to 0.015 inches.

14. The shredding station of claim 11 wherein the shredding knives on one shaft are separated from the bypassing shredding knives on an opposing shaft by a distance below 0.010 inches.

15. The shredding station of claim 14 wherein the shredding knives on one shaft are separated from the bypassing shredding knives on an opposing shaft by a distance of approximately 0.007 inches.

16. The shredding station of claim 11 wherein the knives of the primary shredding station are formed by two side-by side knife portions for forming one thicker knife having a thickness in the range of 17-50 mm.

17. The shredding station of claim 11 wherein the knives of the primary shredding station are made of a unitary knife structure for forming a thicker knife having a thickness in the range of 17-50 mm.

18. The shredding station of claim 11 wherein the knives of the primary shredding station have a hardness of 58-62 on the Rockwell scale.

19. The shredding station of claim 11 wherein the opposing rotating shafts operate at different speeds with one shaft being a faster shaft and another being a slower shaft.

20. The shredding station of claim 1 wherein the faster shaft may operate at a range of 20-60 RPM while the opposing slower shaft may operate at a slower speed in the range of 10-50 RPM.
